(19) United States
(12) Patent Application Publication
(10) Pub. No.: US 2024/0393040 A1
(43) Pub. Date: Nov. 28, 2024

(54) BOIL-OFF GAS RE-LIQUEFYING SYSTEM AND SHIP COMPRISING SAME

(71) Applicant: HD KOREA SHIPBUILDING & OFFSHORE ENGINEERING CO., LTD., Gyeonggi-do (KR)

(72) Inventors: Yeel Yong NOH, Seoul (KR); Jong Wan PARK, Seoul (KR)

(21) Appl. No.: 18/692,977

(22) PCT Filed: Jul. 18, 2022
(86) PCT No.: PCT/KR2022/010464

§ 371 Date: Mar. 18, 2024

(30) Foreign Application Priority Data
Sep. 17, 2021 (KR) 10-2021-0125083

(51) Int. Cl. F25J 1/00; F25J 1/02

(52) U.S. Cl. CPC F25J 1/0025; F25J 1/0229; F25J 1/0277; F17C 2221/032; F17C 2265/034; F17C 2270/0105

(57) ABSTRACT

The present invention relates to a boil-off gas re-liquefying system and a ship including the same, the system, as a system for processing a liquefied gas, which is a heavy hydrocarbon, including: a compressor compressing a boil-off gas generated from a liquefied gas storage tank in multiple stages; a condenser condensing the boil-off gas compressed in the compressor; an intercooler mutually heat-exchanging between a part of the liquid-phase boil-off gas condensed in the condenser and the rest, transferring a gas-phase boil-off gas generated by heat exchange to the compressor, and transferring the liquid-phase boil-off gas to the liquefied gas storage tank; and a liquefied gas pump pressurizing the liquefied gas of the liquefied gas storage tank, wherein the liquefied gas pump transfers a liquefied gas to the intercooler to liquefy the gas-phase boil-off gas in the intercooler.

### TECHNICAL FIELD

The present invention relates to a boil-off gas re-liquefying system and a ship including the same.

### BACKGROUND ART

Among ships that sail the sea with various types of loaded cargo, liquefied gas carriers that transport liquefied gas such as liquefied natural gas or liquefied petroleum gas are provided with a storage tank that forcibly liquefies a gas with a boiling point lower than room temperature and stores it in a liquid state.

Liquefied natural gas is produced by cooling and liquefying methane (CH₄) obtained by refining natural gas collected from gas fields, and it is a colorless and transparent liquid that contains almost no pollutants and has a high calorific value, and thus is an excellent fuel. On the other hand, liquefied petroleum gas is a liquid made of a gas including propane (C₃H₈) and butane (C₄H₁₀) that come out from oil fields together with petroleum as the main ingredients, and is widely used as a fuel for household, business, industrial, and automobile purposes. Liquefied natural gas is reduced to 1/600 in volume by liquefaction, and liquefied petroleum gas is reduced to 1/260 in volume as propane and to 1/230 in volume as butane by liquefaction, and so they have high storage efficiency.

However, although the storage tank storing the liquefied gas has an insulation function, it cannot completely block the vaporization of the liquefied gas. Therefore, in the storage tank, boil-off gas in a gaseous state is generated by the evaporation of the liquefied gas, and since the boil-off gas increases the internal pressure of the storage tank, it needs to be discharged from the storage tank for safety.

To lower the internal pressure of the storage tank, the boil-off gas discharged from the storage tank is combusted and discarded through a gas combustion unit. However, since the boil-off gas is also a part of the cargo carried by a ship, the emission of the boil-off gas is a problem because it reduces the reliability of cargo transportation.

Therefore, in recent years, continuous research and development have been carried out on methods for effectively treating the boil-off gas generated from a storage tank without discarding it.

### DISCLOSURE

### Technical Problem

The present invention was created to solve the problems of the prior art as described above, and an object of the present invention is to provide a boil-off gas re-liquefying system and a ship including the same, wherein the boil-off gas re-liquefying system may increase re-liquefaction efficiency by suppressing the generation itself of a non-condensable gas that may not be condensed upon re-liquefaction of a liquefied gas by using the liquefied gas or by separating the non-condensable gas and processing it.

### Technical Solution

A boil-off gas re-liquefying system according to one aspect of the present invention, as a system for processing a liquefied gas, which is a heavy hydrocarbon, comprises: a compressor compressing a boil-off gas generated from a liquefied gas storage tank in multiple stages; a condenser condensing the boil-off gas compressed in the compressor; an intercooler mutually heat-exchanging between a part of the liquid-phase boil-off gas condensed in the condenser and the rest, transferring a gas-phase boil-off gas generated by heat exchange to the compressor, and transferring the liquid-phase boil-off gas to the liquefied gas storage tank; and a liquefied gas pump pressurizing the liquefied gas of the liquefied gas storage tank, wherein the liquefied gas pump transfers a liquefied gas to the intercooler to liquefy the gas-phase boil-off gas in the intercooler.

Specifically, the intercooler may depressurize a part of the liquid-phase boil-off gas condensed in the condenser with a depressurizing valve and then storing in the inside and pass the rest through the inside to mutually heat exchange with the boil-off gas, and the liquefied gas pump may inject the liquefied gas to the inside of the intercooler so that the liquefied gas drops the temperature of a part of the boil-off gas stored in the intercooler and cools the rest of the boil-off gas passing through the inside of the intercooler.

Specifically, the liquefied gas may be a mixture of a first substance and a second substance with different boiling points, and the intercooler may transfer the first material with a relatively low boiling point to the compressor as a gas-phase boil-off gas during heat exchange with a boil-off gas.

Specifically, the liquefied gas pump may transfer the liquefied gas to the intercooler to limit the evaporation amount of the first material in the intercooler within a preset value.

Specifically, as the system operation time elapses, the first material may continue to circulate through the compressor, the condenser, and the intercooler so that the proportion of the first material in the boil-off gas flowing through the condenser increases, and the liquefied gas pump may transfer the liquefied gas to the intercooler and reduce the flow rate of the first substance transferred from the intercooler to the compressor so that the proportion of the first material in the boil-off gas flowing through the condenser is within a preset value.

Specifically, the liquefied gas pump transfers the liquefied gas to the intercooler when the proportion of the first substance in the boil-off gas flowing through the condenser is greater than or equal to a preset value.

Specifically, a ship according to one aspect of the present invention has the boil-off gas re-liquefying system.

### Advantageous Effects

A boil-off gas re-liquefying system and a ship including the same according to the present invention can innovatively improve re-liquefaction performance by preventing a non-condensable gas from being generated using a low-temperature liquefied gas in a re-liquefaction process of a liquefied petroleum gas or by separating a non-condensable gas and cooling and liquefying it.

### DESCRIPTION OF DRAWINGS

FIG. 1 shows a conceptual diagram of a boil-off gas re-liquefying system according to a first embodiment of the present invention.

FIG. 2 shows a conceptual diagram of a boil-off gas re-liquefying system according to a second embodiment of the present invention.

### MODES OF THE INVENTION

The objects, specific advantages, and novel features of the present invention will become more apparent from the following detailed description and preferred embodiments taken in conjunction with the accompanying drawings. In the present specification, when adding reference numerals to components in each drawing, it should be noted that the same components are given the same numbers as much as possible even when they are shown in different drawings. In addition, in describing the present invention, when it is considered that a detailed description of related known technology or configuration may unnecessarily obscure the gist of the present invention, the detailed description will be omitted.

In the present specification, a liquefied gas is a heavy hydrocarbon, which may be liquefied petroleum gas (LPG; propane, butane, etc.), but it is not limited thereto, and it may encompass any substance (propylene, ammonia, hydrogen, etc.) that is forcibly liquefied for storage because the boiling point is lower than room temperature and that has a calorific value.

In addition, it is noted that in the present specification, a liquefied gas/boil-off gas is classified based on the state inside a tank, and is not necessarily limited to a liquid phase or a gas phase due to the name.

The present invention includes a ship provided with a boil-off gas re-liquefying system described below. At this time, it is noted that a ship is a concept that includes all of gas carriers, merchant ships that transport non-gas cargo or people, floating storage regasification unit (FSRU), floating production storage and offloading (FPSO), bunkering vessels, offshore plants, etc., but it may be a liquefied petroleum gas carrier as an example.

Although not shown in the drawings of the present invention, a pressure sensor (PT), a temperature sensor (TT), or the like may, of course, be provided at an appropriate position without limitation, and values measured by each sensor are used in the operation of the configurations described below in a variety of ways without limitation.

Hereinafter, preferred embodiments of the present invention will be described in detail with reference to the attached drawings.

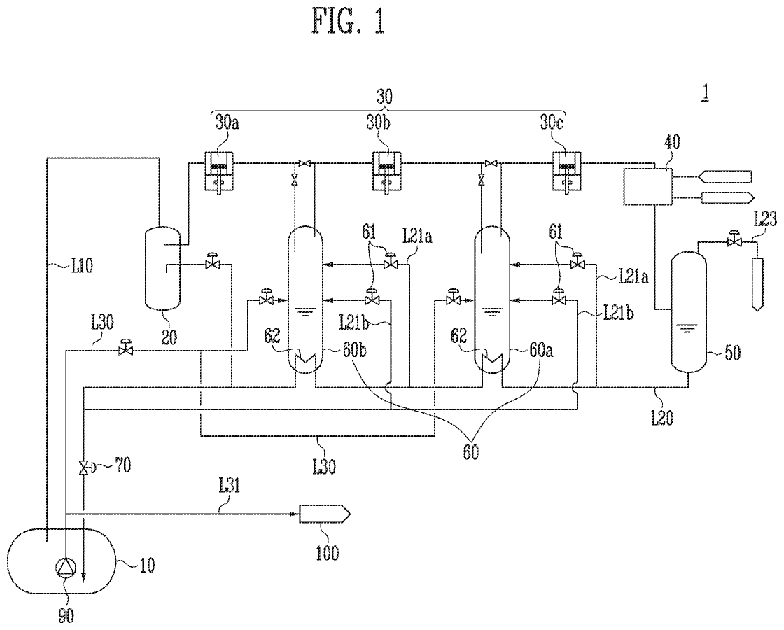

FIG. 1 shows a conceptual diagram of a boil-off gas re-liquefying system according to a first embodiment of the present invention. Referring to FIG. 1, a boil-off gas re-liquefying system 1 according to one embodiment of the present invention includes a liquefied gas storage tank 10, a buffer 20, a compressor 30, a condenser 40, a receiver 50, an intercooler 60, a pressure control valve 70, a liquefied gas pump 90, and a fuel supply portion 100.

A liquefied gas storage tank 10 stores a liquefied gas such as liquefied petroleum gas or ammonia. One or more liquefied gas storage tanks 10 may be provided inside or outside a ship, and may liquefy a gas with a boiling point lower than room temperature and store it in a cryogenic state.

A liquefied gas storage tank 10 may be of a membrane type, an independent type, or a pressure vessel type, but it is not particularly limited. However, regardless of the type, a part of a liquefied gas is spontaneously vaporized inside a liquefied gas storage tank 10 to generate a boil-off gas, and the boil-off gas may be problematic because it causes an increase in the internal pressure of a liquefied gas storage tank 10. Therefore, in the present embodiment, a boil-off gas is discharged to the outside of a liquefied gas storage tank 10, and the discharged boil-off gas may be re-liquefied and returned to the liquefied gas storage tank 10.

Alternatively, in the present invention, a boil-off gas may be used as a fuel for a demand site (reference numeral not shown), and at this time, the demand site may be an engine, a turbine, a boiler, a fuel cell, a burner, etc. provided on a ship, and it may be a propulsion engine that propels a ship or a power generation engine to cover the internal power load of a ship.

A liquefied gas storage tank 10 may be provided with a boil-off gas discharge line L10 for discharging a boil-off gas, and the boil-off gas discharge line L10 may extend from a liquefied gas storage tank 10 to be connected to a boil-off gas re-liquefying system 1.

A buffer 20 is connected to a boil-off gas discharge line L10 and temporarily stores a boil-off gas discharged from a liquefied gas storage tank 10. A buffer 20 is a separator separating a gas phase and a liquid phase, and it performs gas-liquid separation of a boil-off gas discharged from a liquefied gas storage tank 10 and supplies only a boil-off gas of a gaseous state, thereby preventing damage to a compressor 30.

A gas-phase boil-off gas separated in a buffer 20 may be transferred to a compressor 30 through a boil-off gas liquefaction line L20. A boil-off gas liquefaction line L20 is a component that extends from a buffer 20 and transfers a boil-off gas to a liquefied gas storage tank 10 via a condenser 40, and a boil-off gas liquefaction line L20 may be provided with a compressor 30, a condenser 40, a receiver 50, a pressure control valve 70, etc. In addition, a boil-off gas liquefaction line L20 may be provided to pass through an intercooler 60.

A compressor 30 compresses a boil-off gas generated from a liquefied gas storage tank 10. A compressor 30 may be of a centrifugal or reciprocating type, and may be provided in multiple stages including a plurality of compression stages. In addition, a compressors 30 may be provided in parallel for backup or load sharing.

A compressor 30 may compress a boil-off gas flowing in at around 1 bar to 10 to 100 bar, and when a boil-off gas is compressed by a compressor 30, the boiling point of the boil-off gas increases. Therefore, a compressed boil-off gas may be in a liquefiable state even when it is not cooled to the boiling point at atmospheric pressure (for example, −55 degrees in the case of LPG).

A compressor 30 may be composed of three stages, and may compress a boil-off gas to approximately 4 bar in a first stage 30a, approximately 10 bar in a second stage 30b, and approximately 20 to 30 bar in a third stage 30c. Of course, the pressure of a boil-off gas compressed by the compressor 30 and compression stages is not particularly limited.

A plurality of compression stages may be provided in series in a boil-off gas liquefaction line L20 connected from a buffer 20 to a condenser 40 to form a multi-stage compressor 30. In an intermediate stage between compression stages on a boil-off gas liquefaction line L20, a first intercooler 60a and a second intercooler 60b may be connected as an intercooler 60.

A low-pressure boil-off gas that has escaped from a compressor first stage 30a passes through a second intercooler 60b and is then transferred to a compressor second stage 30b, and a medium-pressure boil-off gas that has escaped from the compressor second stage (30b) passes through a first intercooler 60a and then is transferred to a compressor third stage 30c, and it escapes from the compressor third stage 30c as a high-pressure boil-off gas and is transferred to a condenser 40.

At this time, as will be described later, the intercooler 60 is a cooling facility that uses a depressurized boil-off gas as a refrigerant without a separate refrigerant, and it is capable of cooling a low-pressure boil-off gas or a medium-pressure boil-off gas flowing in from a compressor 30. Therefore, an intercooler 60 may implement cooling at an intermediate stage of the compressor 30.

Of course, a compressor 30 may allow a boil-off gas to be transferred between a first stage 30a and a second stage 30b and between a second stage 30b and a third stage 30c, bypassing an intercooler 60, a bypass may be controlled in various ways depending on variables such as the internal pressure of an intercooler 60 and the temperature of a boil-off gas.

A boil-off gas is discharged from a liquefied gas storage tank 10 at around-50 degrees, and after passing through a buffer 20, the discharged boil-off gas may flow into a compressor first stage 30a at around 1 bar and −20 degrees.

After that, the boil-off gas is discharged from the compressor first stage 30a at about 4 bar and about 40 degrees and flows into a second intercooler 60b, and after being cooled to about 30 degrees within the second intercooler 60b, the boil-off gas is transferred to a compressor second stage 30b.

After that, the boil-off gas is discharged from the compressor second stage 30b in a state of about 10 bar and about 70 degrees and flows into a first intercooler 60a, and after being cooled to about 60 degrees in the first intercooler 60a, it is transferred to a compressor third stage 30c. Finally, the boil-off gas is discharged from the compressor third stage 30c in a state of around 20 to 30 bar and around 100 degrees, and then it may be cooled to around 40 degrees in a condenser 40.

However, in situations such as when the temperature of a boil-off gas discharged from each compressor 30 is not relatively high or when discharge of a high-temperature boil-off gas is required, a bypass line (reference numeral not shown) may be provided at a boil-off gas liquefaction line L20 so that a boil-off gas may bypass an intercooler 60.

A bypass line is provided in a boil-off gas liquefaction line L20 so that a compressed boil-off gas bypasses an intercooler 60. For example, a bypass line may be provided so that a boil-off gas compressed in a second stage 30b bypasses a first intercooler 60a to flow into a compressor third stage 30c.

A valve (reference numeral not shown) may be provided at a bypass line, and the opening degree of the valve may be adjusted depending on the load of a compressor second stage 30b or the like or the temperature conditions of a boil-off gas or the like. However, of course, even when a boil-off gas compressed in a compressor 30 bypasses an intercooler 60 along the bypass line, a gas-phase boil-off gas generated within the intercooler 60 may be transferred toward the compressor 30.

In the present embodiment, a compressor 30 is not limited to three stages 30c, and it may have a two-stage structure or a multi-stage structure of four or more stages. However, in the present embodiment, a boil-off gas may be allowed to pass through an intercooler 60 in the process of being compressed.

A condenser 40 cools a compressed boil-off gas and re-liquefies at least a part thereof. At this time, the condenser 40 may re-liquefy the boil-off gas, but it is noted that this does not exclude a situation in which the boil-off gas is not re-liquefied at all or only a part of the boil-off gas is re-liquefied due to various factors during actual operation.

This is because substances with different boiling points are mixed in a boil-off gas. For example, in the case of LPG which includes propane and butane as main ingredients but also includes ethane or the like, the boiling point of ethane is lower than that of propane/butane, and thus some ingredients such as ethane may not be re-liquefied.

A condenser 40 is provided downstream of a compressor 30 provided in multiple stages, and uses various refrigerants (e.g., sea water, fresh water, glycol water, nitrogen, LNG, LPG, propane, R134a, CO₂, etc.) without limitation to cool a boil-off gas.

A condenser 40 may lower the temperature of a boil-off gas compressed in a compressor 30, but may not lower the temperature to the boiling point of the boil-off gas at atmospheric pressure. This is because the boiling point increases as the boil-off gas is compressed by the compressor 30.

However, a condenser 40 may adjust the cooling temperature of a boil-off gas in consideration of the pressure of the boil-off gas discharged from a compressor 30 in the final stage (for example, a third stage 30c).

A receiver 50 temporarily stores a boil-off gas liquefied in a condenser 40. A boil-off gas liquefaction line L20 is provided between a condenser 40 and a liquefied gas storage tank 10 to transfer a cooled boil-off gas to a liquefied gas storage tank 10, and a receiver 50 may be disposed on the boil-off gas liquefaction line L20 downstream of the condenser 40 and upstream of an intercooler 60.

Similar to a buffer 20, a receiver 50 may have a gas-liquid separation function and may transfer a liquefied boil-off gas among cooled boil-off gases to an intercooler 60. However, a receiver 50 may store a non-liquefied boil-off gas among cooled boil-off gases without discharging to the outside, and in this case, as the internal pressure of the receiver 50 increases, when the pressure is reduced by a depressurizing valve 61, which will be described later, the cooling effect of the boil-off gas may be improved.

Of course, in the present embodiment, various modifications are possible such that the receiver 50 may transfer a non-liquefied boil-off gas (non-condensable gas) to a vent header or a liquefied gas storage tank 10 through a vent line L23, or the non-liquefied boil-off gas may be transferred between a compressor third stage 30c and a condenser 40 or the like.

However, a receiver 50 may be omitted, and in this case, a boil-off gas cooled in a condenser 40 may be transferred to an intercooler 60 without separate gas-liquid separation.

An intercooler 60 heat exchanges between a part of a boil-off gas liquefied in a condenser 40 and the rest. An intercooler 60 is branched from a boil-off gas liquefaction line L20 upstream of the intercooler 60 and is connected to a first boil-off gas branch line L21a provided with a depressurizing valve 61, and it is also provided with a cooling flow path 62 which allows the boil-off gas liquefied in the condenser 40 to pass therethrough.

An intercooler 60 has a space for accommodating a boil-off gas depressurized by a depressurizing valve 61, and a first boil-off gas branch line L21a is provided to have an open shape within the intercooler 60 to fill the intercooler 60 with a boil-off gas, and a cooling flow path 62 is provided to pass through the inside of the intercooler 60.

A depressurizing valve 61 provided at a first boil-off gas branch line L21a reduces the pressure of a boil-off gas branched upstream of an intercooler 60 after being cooled by a condenser 40. A depressurizing valve 61 cools a boil-off gas by depressurizing it with a Joule-Thomson valve or an expander (Joule-Thomson effect), and thus the depressurizing valve 61 may liquefy a boil-off gas at a higher rater compared to the boil-off gas cooled by a condenser 40 (or supercooling).

Therefore, an intercooler 60 may allow a cooling flow path 62 of a boil-off gas liquefaction line L20 to pass through the inside of a boil-off gas liquefied by depressurization, thereby enabling stable liquefaction through non-contact heat exchange between boil-off gases without a separate refrigerant. In this respect, an intercooler 60 may be referred to as a heat exchanger and, for example, it may be considered as a bath type heat exchanger. At this time, the cooling flow path 62 may be provided in a coil shape inside a liquefied boil-off gas to improve liquefaction efficiency.

When two or more intercoolers 60 are provided, a depressurizing valve 61 may branch off from the upstream of each intercooler 60 at a boil-off gas liquefaction line L20 and may be provided at each first boil-off gas branch line L21a connected to the intercooler 60. In addition, an intercooler 60 may implement the role of an intermediate stage cooler of a compressor 30 upstream of a condenser 40. An intercooler 60 may be connected to an intermediate stage of a compressor 30 at a boil-off gas liquefaction line L20 to cool a boil-off gas compressed by a part of the plurality of compression stages of the compressor 30 using a decompressed boil-off gas, and it may transfer a boil-off gas generated by heat exchange to the compressor 30.

An intercooler 60 may be provided with a compressed gas inlet (reference numeral not shown) that is connected to a boil-off gas liquefaction line L20 upstream of a condenser 40 to allow a boil-off gas compressed by at least a first stage 30a of a compressor to flow into the inside. A compressed gas inlet may be provided at a position higher than the level of a liquid-phase boil-off gas stored inside an intercooler 60, which is to prevent unnecessary vaporization of a liquefied boil-off gas.

In addition, an intercooler 60 may be provided with a depressurized gas inlet (reference numeral not shown) that is connected to a first boil-off branch line L21a to allow a liquefied boil-off gas to flow into the inside, and it may be provided at a position higher than the level of the boil-off gas within the intercooler 60.

Therefore, a boil-off gas introduced through a compressed gas inlet may be cooled/liquefied while contacting with a boil-off gas liquefied by depressurization. Through this contact-type heat exchange, cooling in a compressor intermediate stage 30 may be implemented by an intercooler 60.

Inside an intercooler 60, a partition wall (reference numeral not shown) facing a compressed gas inlet may be provided, and the partition may prevent a compressed boil-off gas from immediately escaping to a next compressor 30 without being cooled within an intercooler 60.

In the present embodiment, a total of two intercoolers 60 may be provided. A first intercooler 60a may be provided upstream of two intercoolers 60 based on a boil-off gas flow downstream of a condenser 40 and may be provided so that a boil-off gas is introduced between a compressor second stage 30b and a compressor third stage 30c.

In addition, a second intercooler 60b may be provided downstream of the two intercoolers 60 based on the boil-off gas flow downstream of the condenser 40, and may be provided so that a boil-off gas is introduced between a compressor first stage 30a and a compressor second stage 30b.

Therefore, a boil-off gas may be introduced to a compressor first stage 30a-a second intercooler 60b-a compressor second stage 30b-a first intercooler 60a-a compressor third stage 30c-a condenser 40 along a boil-off gas liquefaction line L20 (or bypass an intercooler 60), and the boil-off gas condensed in the condenser 40 may be returned to a liquefied gas storage tank 10 through the first intercooler 60a-the second intercooler 60b-a pressure control valve 70 along the boil-off gas liquefaction line L20.

In this case, the boil-off gas cooled in the condenser 40 at 20 to 30 bar and around 40 degrees may undergo almost no change in pressure while passing through the first intercooler 60a, and the temperature may drop below 30 degrees, and as it further passes through the second intercooler 60b, the temperature may fall below 30 degrees with almost no change in pressure.

Afterwards, when the pressure drops to a level similar to the internal pressure of the liquefied gas storage tank 10 by the pressure control valve 70, the boil-off gas may be cooled to approximately a temperature lower than the boiling point at atmospheric pressure, so it may be finally re-liquefied to be returned to the liquefied gas storage tank 10.

In the present embodiment, in replacement of the first boil-off gas branch line L21a or together with the first boil-off gas branch line L21a, a second evaporation gas branch line L21b may be used. The second boil-off gas branch line L21b has a difference in branch point in the boil-off gas liquefaction line L20 compared to the first boil-off gas branch line L21a.

In other words, the second boil-off gas branch line L21b may be provided to branch at one point downstream of the second intercooler 60b so that branch may each be connected toward the first intercooler 60a and the second intercooler 60b.

However, a second boil-off gas branch line L21b may be provided with a depressurizing valve 61 in the same way as a first evaporation gas branch line L21a, so that a boil-off gas cooled while passing through two intercoolers 60 may be further cooled by depressurization and then transferred to each intercooler 60.

In the present embodiment, both boil-off gas branch lines L21 may be included and at least one boil-off branch line L21 may be included. When both boil-off gas branch lines L21 are included, flow in each boil-off gas branch line L21 may be controlled according to various variables such as the temperature or flow rate of the boil-off gas.

A pressure control valve 70 is provided downstream of a second intercooler 60b and upstream of a liquefied gas storage tank 10 in a boil-off gas liquefaction line L20, and it controls the pressure of a boil-off gas according to the internal pressure of the liquefied gas storage tank 10, for example, it depressurizes the boil-off gas.

A pressure control valve 70 may depressurize a boil-off gas of 20 to 30 bar to around 1 bar to correspond to the internal pressure of a liquefied gas storage tank 10, and it may be a Joule-Thompson valve, etc., in the same way as or in a similar way to a pressure reducing valve 61.

When a pressure control valve 70 depressurizes a boil-off gas, the temperature of the boil-off gas decreases due to pressurization. For example, a boil-off gas that has passed through an intercooler 60 twice along a boil-off gas liquefaction line L20 has a temperature below zero (for example, around −4 degrees), and as it passes through a pressure control valve 70, the temperature of the boil-off gas may decrease to around −40 degrees.

A pressure control valve 70 may be provided alone or serially in a plural number, and this may vary depending on final compression pressure of a multi-stage compressor 30.

A liquefied gas pump 90 pressurizes a liquefied gas in a liquefied gas storage tank 10. A liquefied gas storage tank 10 may be provided with a liquefied gas supply line L31 for supplying a liquefied gas to a demand site (engine, etc.), and the liquefied gas pump 90 transfers a liquefied gas through the liquefied gas supply line L31.

In addition to supplying a liquefied gas to a demand site, a liquefied gas pump 90 may also supply a liquefied gas to an intercooler 60. This is to prevent generation of a non-condensable gas. First, the generation of a non-condensable gas and problems resulting therefrom will be described below.

As mentioned earlier, a boil-off gas may be LPG. In this case, the boil-off gas may be a mixture of a first substance and a second substance with different boiling points. For example, the boil-off gas may be a mixture of ethane, propane, butane, etc. in ascending order of the boiling point.

A boil-off gas is compressed in a compressor 30, condensed in a condenser 40, and then divided and introduced into an intercooler 60 through a receiver 50, and a gas-phase boil-off gas generated within the intercooler 60 is again circulated to the compressor 30. That is, substances that are not liquefied in the intercooler 60 (in particular, ethane, etc. as a first substance with a relatively low boiling point) are continuously circulated.

As system operation time elapses, when a first substance repeatedly circulates through a compressor 30-a condenser 40-a receiver 50-an intercooler 60, the proportion of the first substance may increase compared to the boil-off gas circulating the condenser 40, thereby significantly decreasing liquefaction efficiency in the condenser 40.

To prepare for this, it is needed to block the discharge of the receiver 50 at a certain point according to the proportion of the first substance in the boil-off gas, forcibly raise the discharge pressure of the compressor 30, sufficiently liquefy the first substance in the condenser 40, and then allow a flow of the boil-off gas so that the proportion of the first substance in the gas-phase boil-off gas transferred from the intercooler 60 to the compressor 30 is lowered again. This operation may be referred to as a non-condensable gas processing mode.

Since a non-condensable gas processing mode may be a factor that rapidly reduces re-liquefaction efficiency, in the present embodiment, a liquefied gas may be transferred into an intercooler 60 to prevent vaporization of a first substance within an intercooler 60 so that the operation of the non-condensable gas processing mode may be omitted.

Specifically, a liquefied gas pump 90 may supply a liquefied gas through a liquefied gas transfer line L30 that branches off from a liquefied gas supply line L31 and connects to an intercooler 60, and it may supply the liquefied gas to the intercooler 60 to liquefy a gas-phase boil-off gas in the intercooler 60.

A part of a liquid-phase boil-off gas condensed in a condenser 40 may be depressurized by a depressurizing valve 61 and stored inside an intercooler 60, and the intercooler 60 may passes the rest of the condensed liquid-phase boil-off gas through the inside to mutually heat exchange with the boil-off gas. At this time, the liquefied gas pump 90 may inject the liquefied gas into the intercooler 60, thereby lowering the temperature of a part of the boil-off gas stored inside the intercooler 60.

In addition, as the liquefied gas is injected to the intercooler 60, the rest of the boil-off gas passing through the inside of the intercooler 60 is cooled by a part of the boil-off gas stored in the intercooler 60 and further cooled due to the mixing of the liquefied gas. Therefore, the cooling effect may be increased upon heat exchange between boil-off gases by the intercooler 60.

In other words, an intercooler 60 may utilize a liquefied gas transferred by a liquefied gas pump 90 in cooling (prevent evaporation) a part of the boil-off gas injected to the inside of the intercooler 60, and also utilize it as a refrigerant for a boil-off gas flowing in a cooling flow path 62.

In particular, the present embodiment has an effect of suppressing continuous circulation of a first substance in the sense that a liquefied gas pump 90 transfers a liquefied gas to an intercooler 60, thereby limiting the evaporation amount of the first material within the intercooler 60 to within a preset value.

Specifically, a liquefied gas pump 90 may transfer a liquefied gas to an intercooler 60 to reduce the flow rate of a first substance transferred from the intercooler 60 to a compressor 30 so that the proportion of the first substance in the boil-off gas flowing through the condenser 40 is within a preset value.

Since a liquefied gas pump 90 may operate continuously to supply a liquefied gas to demand site through a liquefied gas supply line L31, transfer of the liquefied gas to an intercooler 60 may be controlled by opening and closing a valve (reference numeral not shown) provided at a liquefied gas delivery line L30.

Alternatively, when the proportion of the first substance in the boil-off gas flowing through the condenser 40 is more than or equal to a preset value, the liquefied gas pump 90 may be controlled to transfer the liquefied gas to the intercooler 60. This control may be used in cases where a liquefied gas fuel is not supplied (when anchored, etc.).

A fuel supply portion 100 processes a liquefied gas supplied from a liquefied gas pump 90 to a demand site in accordance with the requirements of the demand site. A fuel supply portion 100 may include a high-pressure pump (not shown), a heat exchanger (not shown) or the like, and in addition, it may be provided with various components to meet the requirements of the demand site, such as the temperature, pressure, and flow rate of the liquefied gas.

A fuel supply portion 100 may transfer a liquefied gas to a demand site through a liquefied gas supply line L31, or it is also possible to transfer a re-liquefied boil-off gas to a demand site. To this end, a boil-off gas liquefaction line L20 may branch at an appropriate point and be connected to the liquefied gas supply line L31, and a boil-off gas may be supplied to a demand site together with a liquefied gas or alone.

In addition, a demand site may discharge an unconsumed surplus liquefied gas among the supplied liquefied gas, and the surplus liquefied gas discharged from the demand site may be recovered to a fuel supply portion 100 (particularly upstream of a high-pressure pump). To this end, a liquefied gas recovery line (not shown) may be provided as a liquefied gas supply line L31 at a demand site.

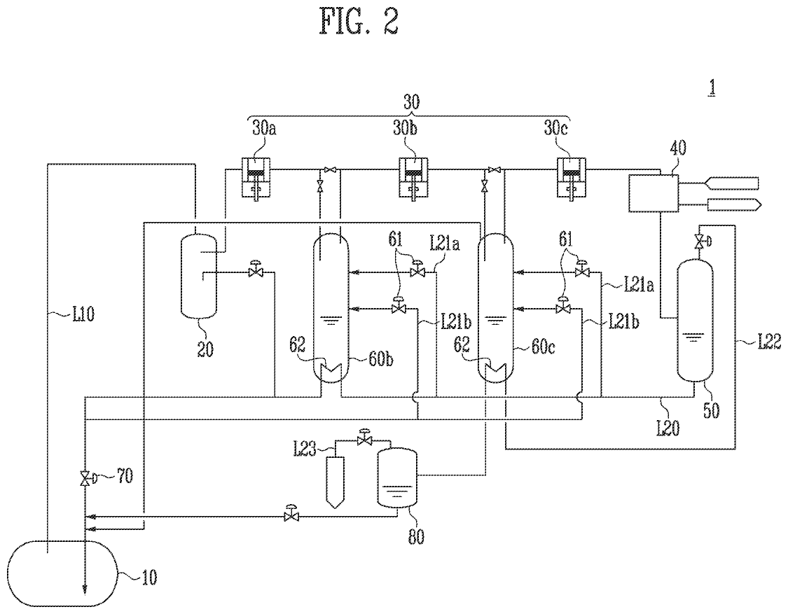

In this way, in the present embodiment, to solve the problem that the liquefaction efficiency is decreased as a first substance with a low boiling point, such as ethane, continuously circulates between an intercooler 60, a compressor 30, and a condenser 40 upon re-liquefying a boil-off gas, a liquefied gas is injected to an intercooler 60 to effectively suppress evaporation of the first material, thereby ensuring sufficient re-liquefaction efficiency. FIG. 2 shows a conceptual diagram of a boil-off gas re-liquefying system according to a second embodiment of the present invention.

Hereinafter, the description will focus on the differences between the present embodiment and the previous embodiment, and parts omitted from the description will be replaced with the previous content.

Referring to FIG. 2, unlike the previous embodiment, a boil-off gas re-liquefying system 1 according to a second embodiment of the present invention has a configuration that separates a non-condensable gas and processes it separately.

In other words, in the present embodiment, to improve the problem that the liquefaction efficiency is decreased as a first substance continuously circulates between an intercooler 60, a compressor 30, and a condenser 40, a non-condensable gas separated from a receiver 50 is separately processed, thereby reducing the proportion of the first material transferred from the intercooler 60 to the compressor 30 and preventing the re-liquefaction efficiency from decreasing due to the non-condensable gas.

Specifically, in the present embodiment, a non-condensable gas separated and discharged from a receiver 50 may be cooled in an additional intercooler 60c (which may also be referred to as a heat exchanger). The additional intercooler 60c will be described in detail below, and a non-condensable gas processing line L22 through which a non-condensable gas flows may be provided from the receiver 50 to the additional intercooler 60c.

An additional intercooler 60c uses at least a part of a liquid-phase boil-off gas transferred from a receiver 50 to cool a non-condensable gas separated from the receiver 50. In the case of the above-described intercooler 60, a part of the boil-off gas condensed in a condenser 40 is depressurized to cool the rest of the boil-off gas, but the additional intercooler 60c may cool the non-condensable gas separated from the receiver 50 through at least a part of the condensed boil-off gas.

At this time, the additional intercooler 60c may be provided to replace the first intercooler 60a, or the additional intercooler 60c may also be provided together with the first and second intercoolers 60. However, the explanation below assumes the former case.

An additional intercooler 60c may depressurize a liquid-phase boil-off gas transferred from a receiver 50 with a depressurizing valve 61 and the store it in the inside, and it is provided to allow a non-condensable gas to pass through a cooling flow path 62 in the inside to heat exchange with the liquid-phase boil-off gas. At this time, the non-condensable gas passing through the inside of the additional intercooler 60c may be cooled by the liquid-phase boil-off gas and then transferred to a liquefied gas storage tank 10.

In addition, similar to the above-described first intercooler 60a, an additional intercooler 60c may transfer a gas-phase boil-off gas generated internally during heat exchange to a compressor 30. Therefore, an additional intercooler 60c may also be used to implement intermediate cooling of a compressor 30.

In addition or alternatively, an additional intercooler 60c may transfer a gas-phase boil-off gas generated by heat exchange to a liquid-phase boil-off gas flowing from an intercooler 60 to a liquefied gas storage tank 10. That is, the additional intercooler 60c may allow the gas-phase boil-off gas to be injected to a boil-off liquefaction line L20, and in this case, the gas-phase boil-off gas transferred from the additional intercooler 60c to the boil-off liquefaction line L20 be joined around a point at which a liquid phase is introduced to the boil-off liquefaction line L20 from a gas-liquid separator, which will be described later.

Even when a non-condensable gas separated from a receiver 50 is cooled by a boil-off gas while passing through the inside of an additional intercooler 60c, it may not be completely re-liquefied, so a gas-liquid separator 80 may be provided to prepare for this, and a non-condensable gas processing line L22 may extend from a receiver 50, pass through an additional intercooler 60c, and then be connected to a gas-liquid separator 80. The gas-liquid separator 80 will be described later.

A gas-liquid separator 80 receives a cooled non-condensable gas and performs gas-liquid separation. A gas-liquid separator 80 is provided on a non-condensable gas processing line L22, and it may be provided between an additional intercooler 60c and a liquefied gas storage tank 10 based on the flow of the non-condensable gas.

As mentioned earlier, a non-condensable gas separated from a receiver 50 may be at least partially liquefied by a boil-off gas in an additional intercooler 60c, but a gas phase may be partially present, and when the gas phase is injected to a liquefied gas storage tank 10, the effect of reducing the proportion of a first substance in a condenser 40 may be reduced.

Therefore, a gas-liquid separator 80 may transfer only a liquid phase of a cooled non-condensable gas to a liquefied gas storage tank 10, and a gas phase may be discharged to the outside (vent header, etc.) through a vent line L23 or supplied to a separate demand site.

In this way, the present embodiment may solve the problem that liquefaction efficiency of a condenser 40 is reduced as continuous circulation of a first substance occurs in the process of re-liquefying a liquefied gas by performing cooling treatment of a non-condensable gas that may be separated from a receiver 50 with a boil-off gas. Therefore, the present embodiment may omit or reduce the need to separately operate a non-condensable gas processing mode, and stable liquefaction performance may be maintained.

In addition to the embodiments described above, the present invention encompasses combinations of the above embodiments and embodiments resulting from a combination of at least one of the above embodiments and known techniques.

Although the present invention has been described above in detail through specific embodiments, these are for specifically explaining the present invention, and the present invention is not limited thereto, and it is clear that modifications and improvements thereof are possible by those skilled in the art within the technical spirit of the present invention.

All simple modifications or changes of the present invention fall within the scope of the present invention, and the specific scope of protection of the present invention will be made clear by the appended claims.

1. A boil-off gas re-liquefying system, as a system for processing a liquefied gas, which is a heavy hydrocarbon, the system comprising:
a compressor compressing a boil-off gas generated from a liquefied gas storage tank in multiple stages;
a condenser condensing the boil-off gas compressed in the compressor;
an intercooler mutually heat-exchanging between a part of the liquid-phase boil-off gas condensed in the condenser and the rest, transferring a gas-phase boil-off gas generated by heat exchange to the compressor, and transferring the liquid-phase boil-off gas to the liquefied gas storage tank; and
a liquefied gas pump pressurizing the liquefied gas of the liquefied gas storage tank,
wherein the liquefied gas pump transfers a liquefied gas to the intercooler to liquefy the gas-phase boil-off gas in the intercooler.

2. The boil-off gas re-liquefying system according to claim 1, wherein the intercooler depressurizes a part of the liquid-phase boil-off gas condensed in the condenser with a depressurizing valve and then storing in the inside and passes the rest through the inside to mutually heat exchange with the boil-off gas, and
the liquefied gas pump injects the liquefied gas to the inside of the intercooler so that the liquefied gas drops the temperature of a part of the boil-off gas stored in the intercooler and cools the rest of the boil-off gas passing through the inside of the intercooler.

3. The boil-off gas re-liquefying system according to claim 1, wherein the liquefied gas is a mixture of a first substance and a second substance with different boiling points, and the intercooler transfers the first material with a relatively low boiling point to the compressor as a gas-phase boil-off gas during heat exchange with a boil-off gas.

4. The boil-off gas re-liquefying system according to claim 3, wherein the liquefied gas pump transfers the liquefied gas to the intercooler to limit the evaporation amount of the first material in the intercooler within a preset value.

5. The boil-off gas re-liquefying system according to claim 3, wherein, as the system operation time elapses, the first material continues to circulate through the compressor, the condenser, and the intercooler so that the proportion of the first material in the boil-off gas flowing through the condenser increases, and
the liquefied gas pump transfers the liquefied gas to the intercooler and reduces the flow rate of the first substance transferred from the intercooler to the compressor so that the proportion of the first material in the boil-off gas flowing through the condenser is within a preset value.

6. The boil-off gas re-liquefying system according to claim 3, wherein the liquefied gas pump transfers the liquefied gas to the intercooler when the proportion of the first substance in the boil-off gas flowing through the condenser is greater than or equal to a preset value.

7. A ship having the boil-off gas re-liquefying system of claim 1.
